(19) United States
(12) Patent Application Publication
(10) Pub. No.: US 2026/0139524 A1
(43) Pub. Date: May 21, 2026

(54) SWITCH ASSEMBLY FOR AN ELECTRICALLY RELEASED DOOR, AND VEHICLE DOOR HANDLE AND VEHICLE DOOR COMPRISING THE SAME

(71) Applicant: MINEBEA ACCESSSOLUTIONS ITALIA S.P.A., Pianezza (IT)

(72) Inventor: David PEDROLETTI, Pianezza (IT)

(73) Assignee: MINEBEA ACCESSSOLUTIONS ITALIA S.P.A., Pianezza (IT)

(21) Appl. No.: 19/392,788

(22) Filed: Nov. 18, 2025

(30) Foreign Application Priority Data
Nov. 20, 2024 (EP) 24214313.9

(51) Int. Cl. E05B 81/76

(52) U.S. Cl. CPC E05B 81/76

(57) ABSTRACT

A switch assembly includes: a housing including a wall and an elastic member attached thereto; and a paddle pivotably mounted on the housing and including a lever. The wall includes fixation members aligned along a virtual pivot axis. A back part of a main extension of the paddle is provided with corresponding fixation members for cooperating with the fixation members of the wall to pivotally attach the paddle to the housing. The paddle is rotatable around the pivot axis from a rest position where the lever does not contact a microswitch, to an active position, when a pressure is exerted on an external surface of the paddle, wherein the lever contacts and activate the microswitch, and wherein the elastic member is compressed transversally to an extension of the wall by an internal surface of the paddle so that when the pressure is reduced, the paddle returns to the rest position.

### CROSS-REFERENCE TO RELATED APPLICATIONS

This application claims priority to and the benefit of EP 24214313.9, filed on November 20, 2024, the disclosure of which is incorporated herein by reference.

### FIELD

The present disclosure relates to the field of vehicle door handles.

### BACKGROUND

The statements in this section merely provide background information related to the present disclosure and may not constitute prior art.

It is known to have a door handle provided with an e-release switch configured to actuate an electrically released door. The door handle comprises a subassembly with a switch paddle mounted on a switch housing, and a lever fixed with a screw on a side of the switch paddle and configured to activate a microswitch when the switch paddle is pressed by the fingers of a user. The switch paddle is biased to return to a rest position using folded metal blades.

The problem with such known door handles is that bent metal blades can fatigue and break over time and under the influence of climatic conditions and of a significant number of cycles of use. Without a real axis of rotation, activation can be difficult if the switch paddle, due to deformation of the paddle, is pressed on the side opposite the microswitch. The microswitch can be damaged in the event of an overload.

Therefore, there is a need for a paddle configured to provide a constant activation load from one side to the other of the paddle, independently of the finger position of the paddle.

There is also a need for a simplified and rapid assembly process, to improve reliability of the e-release switch.

### SUMMARY

This section provides a general summary of the disclosure and is not a comprehensive disclosure of its full scope or all of its features.

To that end, the present invention provides a switch assembly for an electrically released door handle. The switch assembly includes a paddle, and a housing. The housing comprises a wall and at least one elastic member attached to the wall, the wall further comprising at least two fixation members secured to the wall, the at least two fixation members being aligned along a virtual pivot axis. The paddle is pivotally mounted on the housing, a back part of a main extension of the paddle being provided with at least two corresponding fixation members configured to cooperate with the at least two fixation members of the wall of the housing to pivotally attach the paddle to the housing. The paddle further includes a lever. The paddle is mobile in rotation around the pivot axis from a paddle rest position wherein the lever is not in contact with a microswitch, to a paddle active position, when a pressure is exerted on an external surface of the paddle, wherein the lever is in contact with the microswitch to activate the microswitch, and wherein the elastic member is compressed transversally to an extension of the wall of the housing by an internal surface of the paddle so that when the pressure exerted on the paddle is reduced, the paddle returns to the paddle rest position.

According to these provisions, the switch comprises only few components and no screws, so that the assembly process is simplified and the reliability of the switch improved.

According to an embodiment, the invention comprises one or more of the following features, alone or in any combination technically compatible.

According to an embodiment, the paddle is made of a rigid material, such as glass fiber reinforced plastic.

According to these provisions, the deformation of the paddle is reduced in case the pressure is exerted on an end of the paddle opposite to the microswitch. In other words, the pressure exerted by the lever on the microswitch is independent of where on the paddle the pressure is exerted by the finger of a user.

According to an embodiment, the rigid material is covered on the external surface with a flexible material, such as an ethylene polymer.

According to these provisions, the sensation for the users is more comfortable.

According to an embodiment, at least one of the at least two fixation members is a hinge knuckle. At least one of the at least two corresponding fixation members is a hinge pin configured to be inserted in the hinge knuckle.

According to these provisions, the corresponding fixation members form an axis of rotation so that deformation of the paddle is reduced in case the pressure is exerted on an end of the paddle opposite to the microswitch.

According to an embodiment, the paddle is mobile in translation along the virtual pivot axis from a detached position. The paddle is detached from the housing to an attached position wherein the at least one hinge pin is inserted in the at least one hinge knuckle wherein the paddle is pivotally attached to the housing.

According to these provisions, the switch assembly process does not need any screw, so that the assembly process is simplified and the reliability of the switch improved.

According to an embodiment, the paddle further comprises a clipping member configured to abut on a clipping hook secured to the wall of the housing when the paddle is pivotally attached to the housing, preventing the paddle from translating back from the attached position to the detached position, i.e. preventing the paddle from detaching from the housing.

According to an embodiment, the at least one elastic member is a coil spring.

According to an embodiment, the at least one coil spring is fixed to the wall of the housing using a stud protruding from the wall of the housing. The stud is inserted inside the coil spring to maintain the coil spring in a compression direction transversally to the extension of the wall of the housing.

According to an embodiment, the stud is cross shaped.

According to an embodiment, the paddle is provided with at least one spring housing formed on the internal surface of the paddle, a shape of the spring housing being elongated in an elongation direction parallel to the virtual pivot axis, and comprising a first portion and a second portion, a dimension of the first portion, transversally to the elongated direction, being larger than a dimension of the second portion, transversally to the elongated direction, the dimension of the second portion being adjusted to a diameter of an end of the coil spring, the at least one spring housing being configured to receive the end of the at least on coil spring inside the first portion when the paddle is in the detached position, and inside the second portion when the paddle is in the attached position.

According to an embodiment, the at least one spring housing formed on the internal surface of the paddle comprises a wall protruding from the internal surface of the paddle and delimiting the shape of the spring housing.

According to these provisions, the spring housing corresponding to the end of the coil spring is made in the shape of an egg, so as to leave sufficient play around the spring when inserting the paddle. Once the paddle is clipped in the final position, the end of the coil spring is in the narrower part of the egg-shaped spring housing, so as to reduce the space around the coil spring and optimize the guiding of the spring.

According to an embodiment, the lever is an integral part of the paddle.

According to these provisions, the switch assembly comprises only two components so that the assembly process is further simplified and the reliability of the switch further improved.

According to an embodiment, a front part of the main extension of the paddle is provided with a mechanical stop configured to cooperate with a stop area on the housing at an end of a rotation stroke of the paddle around the pivot axis when a pressure is exerted on the external surface of the paddle.

According to an embodiment, the lever is provided with a lever mechanical stop configured to cooperate with a lever stop area on the housing to protect the microswitch from an extra load on the lever.

According to an embodiment, the housing is configured to be mounted on a bracket, the wall being provided with two rims extending along opposite ends of the extension of the wall, transversally to the virtual pivot axis, each rim being configured to be inserted into a groove of the bracket, each rim being further provided with at least one protruding member, such as a half-sphere, configured to cooperate with a corresponding member of the groove to determine the insertion position of the housing.

According to an embodiment, the housing is further provided with a clipping member configured to cooperate with a corresponding clipping member of the bracket to fix the housing to the bracket in a final position, so that in the final position the clipping member is maintained between a surface of the bracket and another surface of the corresponding clipping member, the surface and the other surface facing each other, the clipping member being in contact with the surface of the bracket.

According to these provisions, the switch assembly process does not need any screw, so that the assembly process is simplified and the reliability of the switch improved.

According to an aspect, the disclosure relates to a vehicle door handle comprising a switch assembly according to anyone of the embodiments described herein above.

According to an aspect, the disclosure relates to a vehicle door comprising a vehicle door handle comprising a switch assembly according to anyone of the embodiments described herein above.

Further areas of applicability will become apparent from the description provided herein. It should be understood that the description and specific examples are intended for purposes of illustration only and are not intended to limit the scope of the present disclosure.

### DRAWINGS

The foregoing and other purposes, features, aspects and advantages of the invention will become apparent from the following detailed description of embodiments, given by way of illustration and not limitation with reference to the accompanying drawings, in which the same reference refer to similar elements or to elements having similar functions, and in which:

FIG. 1 is an exploded view of a switch assembly comprising a paddle mounted on a housing, and a lever configured to activate a microswitch when the paddle is pressed to rotate around the pivot axis A.

FIG. 2 is a cross-sectional view, in a plane transversal to the pivot axis, of the switch assembly according to an example embodiment, representing the paddle and the lever in two different angular positions along the rotation stroke of paddle around the pivot axis.

FIG. 3 is a perspective view of the switch assembly according to an example embodiment, representing the lever of the paddle interacting with the microswitch.

FIG. 4a is a cross-sectional view, in a plane containing the pivot axis, of the switch assembly according to an example embodiment, wherein the hinge pins and hinge knuckles are in a detached position of the paddle.

FIG. 4b is a view similar to FIG. 4a with the hinge pins and hinge knuckles in an attached position.

FIG. 5 is a view of the attachment of the coil spring on the wall of the housing of the switch assembly according to an example embodiment.

FIG. 6a is a view of an egg-shaped spring housing configured to receive the coil spring on the internal surface paddle of the switch assembly in the detached position of the paddle, according to an example embodiment of the switch assembly.

FIG. 6b is a view similar to FIG. 6a, with the egg-shaped spring housing configured to receive the coil spring on the internal surface paddle of the switch assembly in the attached position of the paddle.

FIG. 7 is a perspective view of a housing of the switch assembly according to an example embodiment representing the stop area arranged on the housing to cooperate with a mechanical stop on the paddle at the end of rotation stroke of the paddle, and representing another stop area arranged on the housing to cooperate with another mechanical stop on the lever of the paddle at the end of rotation stroke of the paddle.

FIG. 8 represents a sequence of steps a, b, c, d to insert the housing of the switch assembly inside the grooves of a bracket, according to an example embodiment.

FIG. 9 represents a view of an interface of the housing of the switch assembly according to an example embodiment, with the grooves of the bracket.

FIG. 10 represents a sequence of steps e, f, g, h, i to clip the housing of the switch assembly according to an example embodiment, in its final position when it is attached to the bracket.

FIG. 11 represents the clipping mechanism of the housing of the switch assembly according to an example embodiment, in the final position of the housing when it is attached to the bracket.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

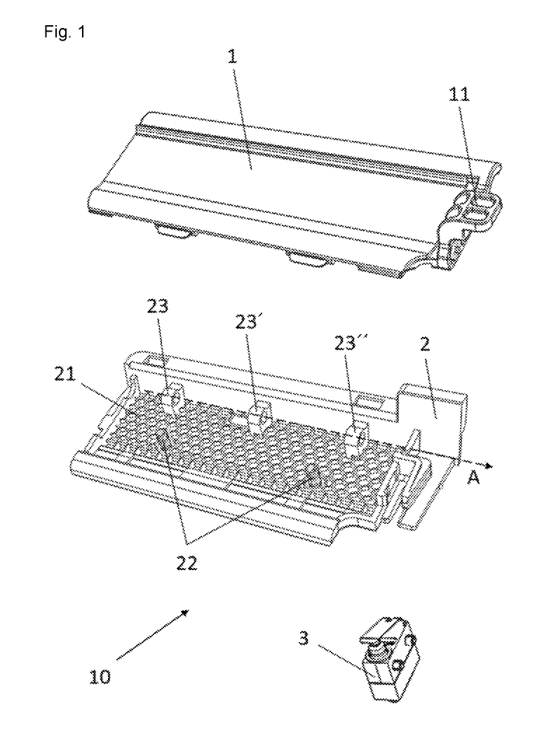

FIG. 1 represents the main components of a door handle switch assembly 10 for an electrically released door. The door handle switch assembly 10 comprises a paddle 1 mounted on a housing 2. The paddle 1 comprises a lever 11 configured to activate a microswitch 3 when the paddle 1 is pressed, for example, by the fingers of a user.

The housing 2 comprises a wall 21 and at least one elastic member 22, for example, at least one coil spring 22, attached to the wall 21. The wall 21 further comprises at least two fixation members 23, 23’, 23”. The at least two fixation members 23, 23’, 23” are aligned along a virtual pivot axis A.

Optionally, the at least one coil spring 22 is fixed to the wall 21 of the housing 2 using a stud 25 protruding from the wall 21 of the housing 2. The stud 25 is inserted inside the coil spring 22 to maintain the coil spring 22 in a compression direction transversally to the extension of the wall 21 of the housing 2. As an example, the stud 25 is cross shaped, as illustrated in FIG. 5.

The paddle 1 is pivotally mounted on the housing 2, a back part of a main extension of the paddle 1 being provided with at least two corresponding fixation members 13, 13’, 13’’ configured to cooperate with the at least two fixation members 23, 23’, 23’’ of the wall of the housing to pivotally attach the paddle 1 to the housing 2.

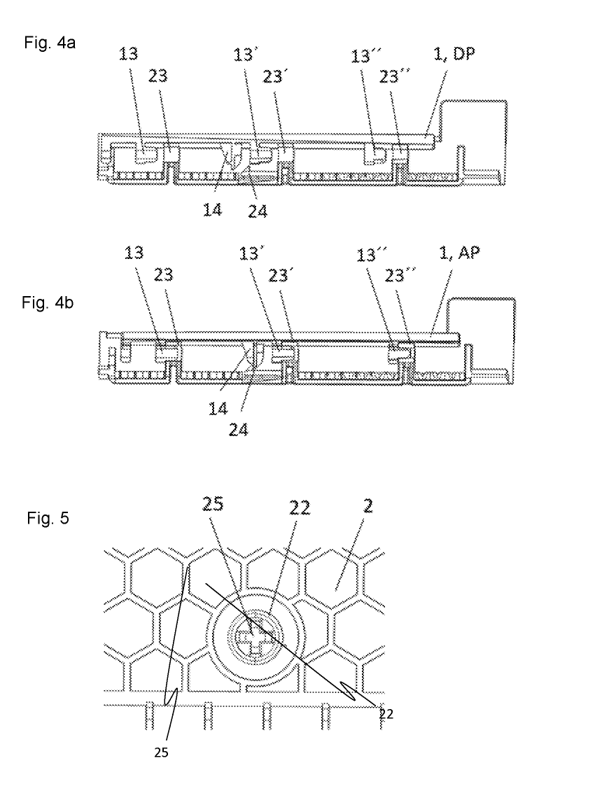

For example, as illustrated in FIG. 4, the paddle 1 is mobile in translation along the virtual pivot axis A from a detached position DP, wherein the paddle 1 is detached from the housing 2 as represented on FIG. 4a, to an attached position AP wherein the at least one hinge pin 13, 13’, 13” is inserted in the at least one hinge knuckle 23, 23’, 23” wherein the paddle 1 is pivotally attached to the housing 2, as represented in FIG. 4b.

In particular, at least one of the at least two fixation members 23, 23’, 23” is a hinge knuckle, and at least one of the at least two corresponding fixation members 13, 13’, 13” is a hinge pin configured to be inserted in the hinge knuckle.

Thus, the corresponding fixation members form at least a portion of a real physical axis of rotation, so that deformation of the paddle is reduced in case the pressure is exerted on an end of the paddle opposite to the microswitch.

Optionally, as illustrated in FIGS. 4a and 4b, the paddle 1 further comprises a clipping member 14 configured to abut on a clipping hook 24 secured to the wall 21 of the housing 2 when the paddle 1 is pivotally attached to the housing 2, preventing the paddle 1 from translating back from the attached position AP to the detached position DP, i.e. preventing the paddle 1 from detaching from the housing 2.

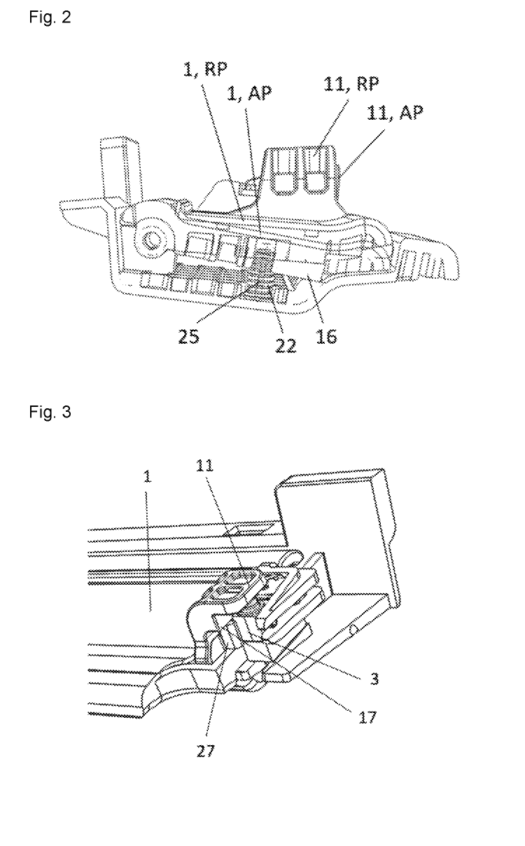

The paddle 1 is thus mobile in rotation around the pivot axis A from a paddle rest position RP wherein the lever 11 is not in contact with the microswitch 3, as represented in FIG. 2, to a paddle active position AP, when a pressure is exerted on an external surface of the paddle 1, for example by a finger of a user, wherein a lever 11 is in contact with the microswitch 3 to activate the microswitch 3, and wherein the elastic member 22 is compressed transversally to an extension of the wall 21 of the housing 2 by an internal surface of the paddle 1, so that when the pressure exerted on the paddle 1 is reduced, the paddle 1 returns to the rest position RP, as represented in FIG. 2 wherein position RP is represented with an angular position slightly higher than angular position AP.

According to these provisions, the switch comprises only few components and no screws, so that the assembly process is simplified and the reliability of the switch improved.

In particular, the paddle 1 is made of a rigid material, such as glass fiber reinforced plastic, so that the deformation of the paddle 1 is reduced in case the pressure is exerted on an end of the paddle 1 opposite to the microswitch 3; in other words, the pressure exerted by the lever 11 on the microswitch 3 is independent of where on the paddle 1 the pressure is exerted by the finger of a user.

Optionally, the rigid material is covered on the external surface with a flexible material, such as an ethylene polymer, so that the sensation for the users is more comfortable.

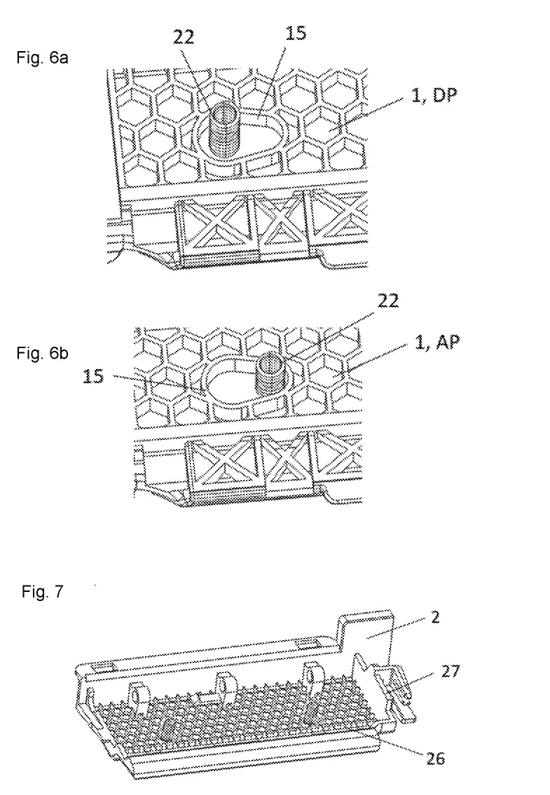

As illustrated in FIGS. 6a and 6b, the paddle 1 is provided with at least one spring housing 15 formed on the internal surface of the paddle 1, a shape of the spring housing 15 being elongated in an elongation direction parallel to the virtual pivot axis A, and comprising a first portion and a second portion, a dimension of the first portion, transversally to the elongated direction, being larger than a dimension of the second portion, transversally to the elongated direction, the dimension of the second portion being adjusted to a diameter of an end of the coil spring 22. Thus, the at least one spring housing 15 is configured to receive the end of the at least on coil spring 22 inside the first portion when the paddle 1 is in the detached position DP, as illustrated in FIG. 6a, and inside the second portion when the paddle 1 is in the attached position AP, as illustrated in FIG. 6b.

In particular, the spring housing 15 formed on the internal surface of the paddle 1 may comprise a wall protruding from the internal surface of the paddle 1 and delimiting the shape of the spring housing 15.

More specifically, the spring housing 15 corresponding to the end of the coil spring 22 may have a shape similar to an egg shape, so as to leave sufficient play around the coil spring 22 when inserting the paddle 1 onto the hinge knuckles 23, 23’, 23’’ of the housing 2. Once the paddle 1 is clipped in the final position, the end of the coil spring 22 is in the narrower portion of the egg-shaped spring housing 15, so as to reduce the space around the coil spring 22 and optimize the guiding of the spring 22 when it is compressed.

Optionally, the lever 11 is an integral part of the paddle 1, so that the switch assembly 10 comprises only two integral components, the paddle 1 and the housing 2, the assembly process being thus further simplified and the reliability of the switch further improved.

As an exemplary embodiment, a front part of the main extension of the paddle 1 is provided with a mechanical stop 16, as represented in FIG. 7, said mechanical stop 16 being configured to cooperate with a stop area 26 on the housing 2 at an end of a rotation stroke of the paddle 1 around the pivot axis A when a pressure is exerted on the external surface of the paddle 1.

Optionally, the lever 11 is also provided with a lever mechanical stop 17 configured to cooperate with a lever stop area 27, as represented in FIG. 7, on the housing 2 to protect the microswitch 3 from an extra load on the lever 11.

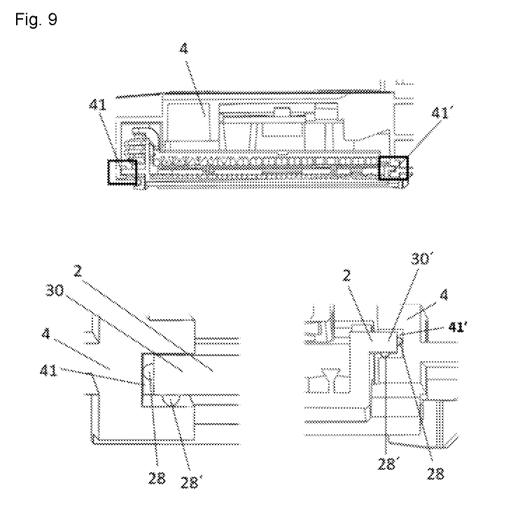

As represented in FIG. 9, the housing 2, assembled with the paddle 1, is configured to be mounted on a bracket 4, the wall 21 being provided with two rims 30, 30’ extending along opposite ends of the extension of the wall 21, transversally to the virtual pivot axis A, each rim 30, 30’ being configured to be inserted into a groove 41, 41’ of the bracket 4, each rim being further provided with at least one protruding member 28, 28’, such as a half-sphere, configured to cooperate with a corresponding member of the groove 41, 41’ to determine the insertion position of the housing 2.

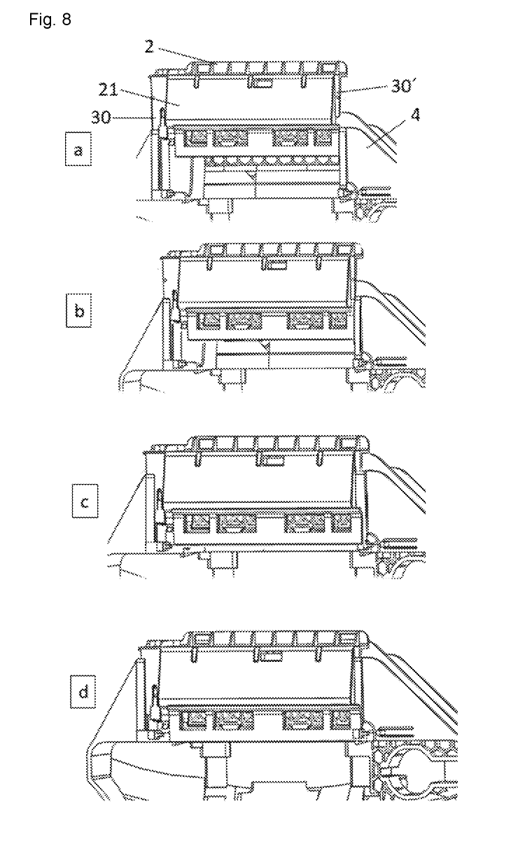

In FIG. 8, different steps a, b, c, and d of the mounting process are represented.

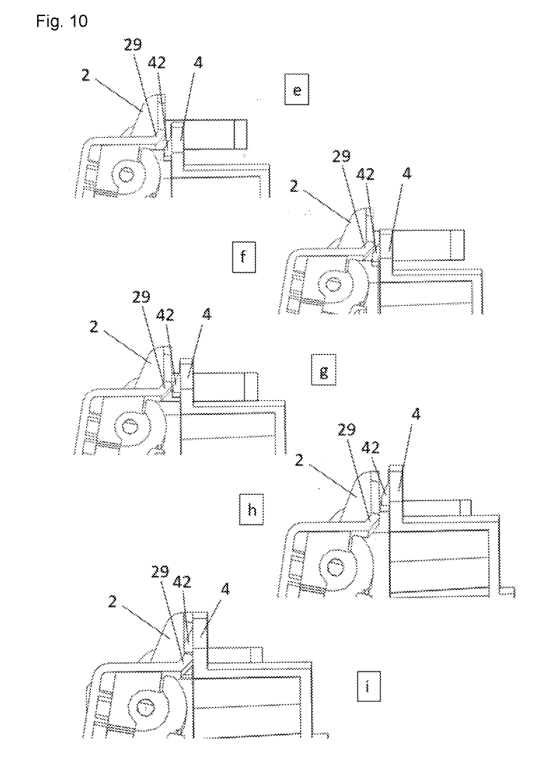

In a final step d of the mounting process, the housing 2 is clipped to the bracket 4, as illustrated in FIG. 10, wherein different steps e, f, g h, I of the final clipping process are further represented.

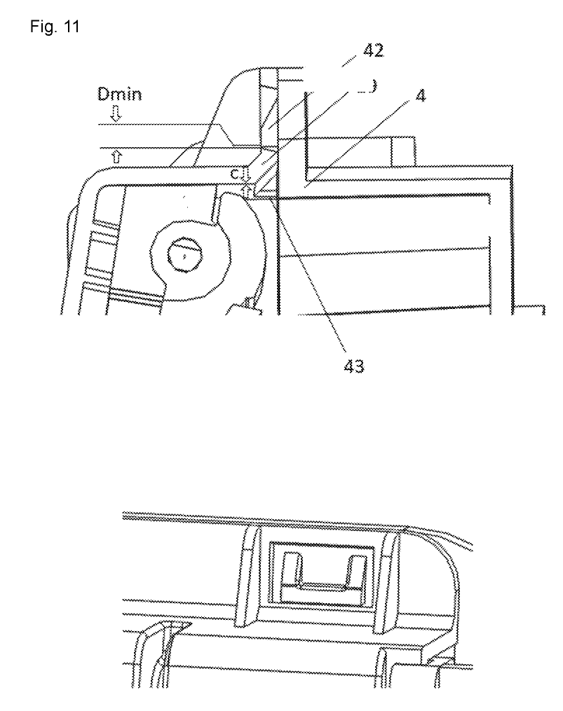

To enable a final clipped attachment of the housing 2 with the bracket 4, the housing 2 is further provided with a clipping member 29 configured to cooperate with a corresponding clipping member 42 of the bracket 4 to fix the housing 2 to the bracket 4 in a final position, so that in said final position, the clipping member 29 is maintained between a surface 43 of the bracket 4 and another surface of the corresponding clipping member 42, the surface and the other surface facing each other, the clipping member 29 being in contact C with the surface 43 of the bracket 4, as represented in FIG. 11. A minimum distance Dmin is left between the clipping member 29 and the other surface of the corresponding clipping member 42, so that the clipping process can be completed.

Thus, the switch assembly process does not need any screw, so that the assembly process is simplified and the reliability of the switch improved.

According to an aspect, the disclosure relates also to a vehicle door handle comprising a switch assembly 10 according to anyone of the preceding examples described hereinabove.

According to a further aspect, the disclosure relates also to a vehicle door comprising a vehicle door handle according to the preceding the preceding examples described hereinabove.

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A switch assembly for an electrically released door handle, the switch assembly comprising:
a paddle comprising a lever; and
a housing comprising a wall and at least one elastic member attached to the wall, the wall further comprising at least two fixation members secured to the wall, the at least two fixation members being aligned along a virtual pivot axis,
wherein the paddle is pivotally mounted on the housing, a back part of a main extension of the paddle being provided with at least two corresponding fixation members configured to cooperate with the at least two fixation members of the wall of the housing to pivotally attach the paddle to the housing,
the paddle being mobile in rotation around the pivot axis from a paddle rest position where the lever is not in contact with a microswitch, to a paddle active position, when a pressure is exerted on an external surface of the paddle, wherein the lever is in contact with the microswitch to activate the microswitch, and wherein the elastic member is compressed transversally to an extension of the wall of the housing by an internal surface of the paddle so that when the pressure exerted on the paddle is reduced, the paddle returns to the paddle rest position.

2. The switch assembly according to claim 1, wherein the paddle is made of a rigid material, such as glass fiber reinforced plastic.

3. The switch assembly according to claim 2, wherein the rigid material, is covered on the external surface with a flexible material, such as an ethylene polymer.

4. The switch assembly according to claim 1, wherein at least one of the at least two fixation members is a hinge knuckle, and wherein at least one of the at least two corresponding fixation members is a hinge pin configured to be inserted in the hinge knuckle.

5. The switch assembly according to claim 4, wherein the paddle is mobile in translation along the virtual pivot axis from a detached position, wherein the paddle is detached from the housing, to an attached position wherein the at least one hinge pin is inserted in the at least one hinge knuckle wherein the paddle is pivotally attached to the housing.

6. The switch assembly according to claim 5, wherein the paddle further comprises a clipping member configured to abut on a clipping hook secured to the wall of the housing when the paddle is pivotally attached to the housing, preventing the paddle from translating back from the attached position to the detached position, i.e. preventing the paddle from detaching from the housing.

7. The switch assembly according to claim 1, wherein the at least one elastic member is a coil spring.

8. The switch assembly according to claim 7, wherein the at least one coil spring is fixed to the wall of the housing using a stud protruding from the wall of the housing, the stud being inserted inside the coil spring to maintain the coil spring in a compression direction transversally to the extension of the wall of the housing.

9. The switch assembly according to claim 7, wherein the paddle is provided with at least one spring housing formed on the internal surface of the paddle, a shape of the spring housing being elongated in an elongation direction parallel to the virtual pivot axis, and comprising a first portion and a second portion, a dimension of the first portion, transversally to the elongated direction, being larger than a dimension of the second portion, transversally to the elongated direction, the dimension of the second portion being adjusted to a diameter of an end of the coil spring, the at least one spring housing being configured to receive the end of the at least on coil spring inside the first portion when the paddle is in a detached position, and inside the second portion when the paddle is in the attached position.

10. The switch assembly according to claim 1, wherein the lever is an integral part of the paddle.

11. The switch assembly according to claim 1, wherein a front part of the main extension of the paddle is provided with a mechanical stop configured to cooperate with a stop area on the housing at an end of a rotation stroke of the paddle around the pivot axis when a pressure is exerted on the external surface of the paddle.

12. The switch assembly according to claim 1, wherein the lever is provided with a lever mechanical stop configured to cooperate with a lever stop area on the housing to protect the microswitch from an extra load on the lever.

13. The switch assembly according to claim 1, wherein the housing is configured to be mounted on a bracket, the wall being provided with two rims extending along opposite ends of the extension of the wall, transversally to the virtual pivot axis (A), each rim being configured to be inserted into a groove of the bracket, each rim being further provided with at least one protruding member, such as a half-sphere, configured to cooperate with a corresponding member of the groove to determine an insertion position of the housing.

14. The switch assembly according to claim 13, wherein the housing is further provided with a clipping member configured to cooperate with a corresponding clipping member of the bracket to fix the housing to the bracket in a final position, so that in the final position the clipping member is maintained between a surface of the bracket and another surface of the corresponding clipping member, the surface and the other surface facing each other, the clipping member being in contact with the surface of the bracket.

15. A vehicle door handle comprising the switch assembly according to claim 1.

16. A vehicle door comprising the vehicle door handle according to claim 15.
